(19) United States
(12) Patent Application Publication
(10) Pub. No.: US 2025/0207675 A1
(43) Pub. Date: Jun. 26, 2025

(54) Cartridge Check Valve

(71) Applicant: Curtis Alan Roys, Fredericksburg, TX (US)

(72) Inventor: Curtis Alan Roys, Fredericksburg, TX (US)

(21) Appl. No.: 18/972,784

(22) Filed: Dec. 6, 2024

Related U.S. Application Data
(60) Provisional application No. 63/607,550, filed on Dec. 7, 2023.

(51) Int. Cl. F16K 15/04

(52) U.S. Cl. CPC F16K 15/042; F16K 15/044; F16K 2200/501

(57) ABSTRACT

A cartridge check valve includes a body and removeable cartridge. The check valve protects itself from failure by forming an oil barrier between hot gas and debris and the sealing components. If sealing areas in the cartridge check valve fail, the cartridge can be removed and replaced with another replaceable cartridge. The body of the check valve typically does not need to be replaced, thereby reducing carbon footprint. A preferred cartridge includes two balls, each ball sealing against a seating surface to form two seals within the cartridge.

### TECHNICAL FIELD OF THE INVENTION

The present invention relates to force feed lubrication systems, and in particular to check valves for a divider block force feed lubrication system,

### BACKGROUND OF THE INVENTION

Check valves are a small but vital part of force feed lubrication systems. Incorrect installation or failure of a check valve can create problems with a force feed divider block lubrication system, which in turn will cause premature wear and failure of compressor cylinders, piston rings rods, and packing patterns. There are two jobs associated with check valves in force feed lubrication systems: keeping the tubing lines filled with oil during compressor shutdowns; and preventing hot gas and debris from entering the lubrication system.

During shutdown or when a check valve fails when the compressor is running, injection check valves that begin leaking will permit gas to migrate into the tubing, allowing oil to drain from the tubing that supplies oil to the lube injection point. When the compressor is restarted, the tubing must be refilled before any oil will be injected into the lube point. A number six divider block is designed to dispense 6 thousandths of a cubic inch of oil with each cycle of the divider block piston. Six thousandths of a cubic inch of oil is approximately 2 drops of oil, and that minuscule amount of oil means that it will take about 17 minutes to refill just 12 inches of quarter inch tubing. Using a typical 20 second cycle time, it will take approximately 170 minutes to fill a 10 foot length of ¼ inch tubing or approximately 3 hours before the lubrication point receives lubrication. Great damage can be done to the wear components if a compressor runs unlubricated for that long.

When check valves continue to seal efficiently during a compressor shutdown, oil is prevented from draining out of the tubing. When the compressor is re-started, oil is delivered to the lubrication points upon the first cycle of the divider block assembly. When the divider block piston completes its stroke, the check valve allows oil to be injected into the lubrication point and closes immediately, blocking hot gas and debris from entering the lube lines. If hot gas is allowed to enter the lube line, the check valve has failed. Gas will migrate into the divider block assembly causing pistons in the assembly to lock up, system pressures to increase, rupture discs will blow, and the compressor will shut down. With older style designs there are devices called check valve protectors which can be installed at the injection point to form an oil barrier between the check valve and the injection point, preventing hot gas and debris from entering the valve, protecting the sealing surfaces. The downside of this design is that it requires a separate device, adding costs and potential leak paths

### SUMMARY OF THE INVENTION

An object of the invention is to provide an improved check valve and a method for repairing a check valve for a force fee lubrication system.

A cartridge check valve includes a body and removeable cartridge. If the cartridge check valve fails, the removable cartridge can be removed and replaced with another replaceable cartridge. A preferred cartridge includes two balls that form two seals within the cartridge.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIG. 1 shows a cartridge check valve with a fitting attached to the input end;

FIG. 2 shows a cartridge check valve mounted on a lubricated system;

FIG. 3 shows the cartridge check valve with the fitting separated;

FIG. 4 shows a cartridge check valve with the cartridge separated;

FIG. 5 shows a cross sectional view of a cartridge for a cartridge check valve;

FIG. 6 shows another cross sectional view of a cartridge for a cartridge check valve with the balls displaced from their respective seats by the pressure of the incoming lubricant;

FIG. 7 shows a cross sectional view of a cartridge check valve with the cartridge inserted;

FIG. 8 shows a cartridge check valve connected on both ends to a lubrication line;

FIG. 9 shows a cross section of another embodiment of the cartridge check valve;

FIG. 10 shows a cross section of another embodiment of the cartridge check valve; and

FIG. 11 is a flow chart showing the process of repairing a cartridge check valve.

### DETAILED DESCRIPTION OF PREFERRED EMBODIMENTS

A preferred embodiment of the invention provides a one device solution that integrates an oil barrier into the check valve itself. An oil barrier is a wetted area that holds oil and eliminates gas from reaching the sealing surfaces of the check valve ball and seat. This reduces the possibility for hot gas and trash from causing the check valve to fail because it can never reach the balls and seats of the check valve. The cartridge check valve or CCV has two parts: a body, typically of stainless steel, and a replaceable cartridge. The replaceable cartridge contains 2 balls, typically of stainless steel, each of which is spring loaded against a precision machined seating surface. If a check valve fails, the user simply removes the old internal cartridge and screws in a replacement cartridge. The cartridge can preferably be removed and replaced in less than 60 seconds. The CCV preferably uses a dual outlet flow path, as opposed to conventional check valves that use a single flow path which can be blocked with debris in the gas stream. The dual flow path design ensures oil will continue to flow even if one side gets temporarily blocked.

If the internal cartridge should fail, the user does not need to dispose of the body—he just replaces the cartridge. The cartridge can also preferably be rebuilt. This reduces the environmental footprint and raises the user's ESG score. The CCV ensures the lube lines stay filled with oil even during prolonged compressor downtime and protects vital components of the force feed lubrication system from hot gas and debris. The cartridge check valve eliminates needless downtime of the compressor saving money.

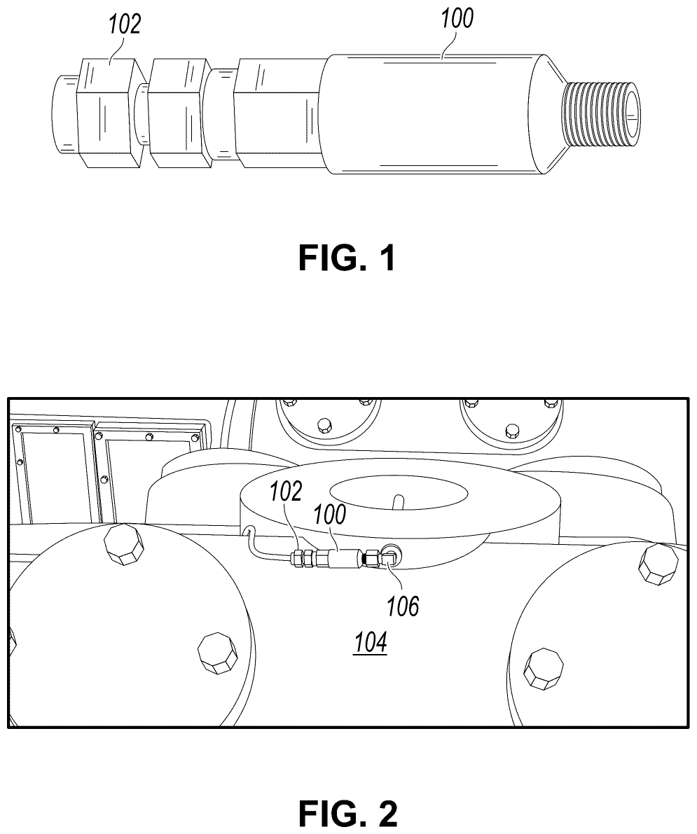

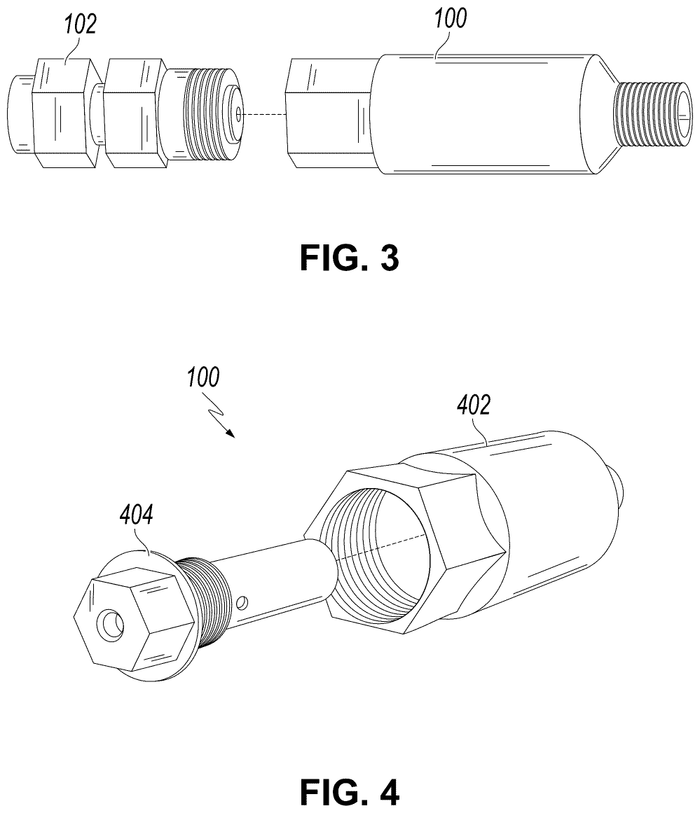

FIG. 1 shows a cartridge check 100 with a fitting 102 for connecting a ¼ tube for supplying lubricant into the cartridge check valve 100. FIG. 2 shows the cartridge check 100 and fitting 102 positioned on lubricated equipment 104 with a second fitting 106 to connect an output tube. FIG. 3 shows the cartridge check valve 100 with the fitting 102 separated. FIG. 4 shows that the CCV 100 comprises a body 402 and a replaceable cartridge 404.

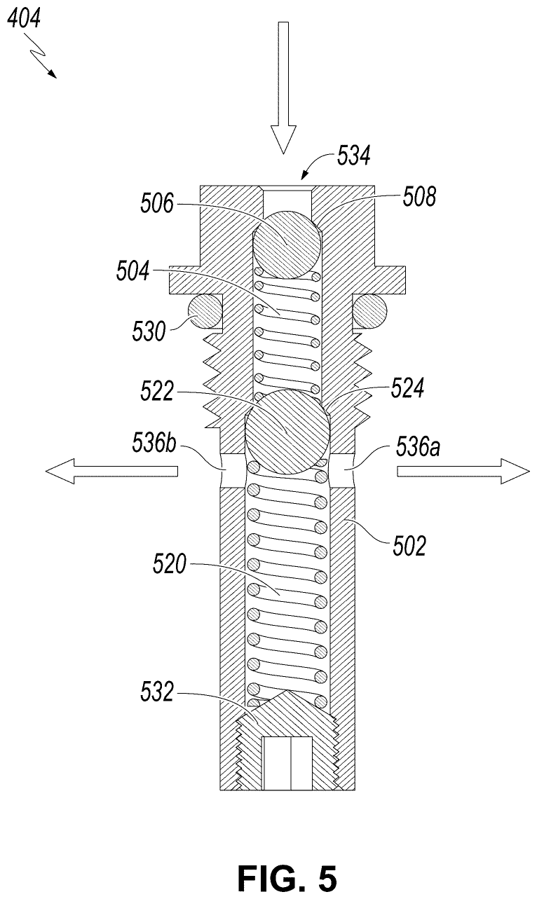

FIG. 5 shows a cross section of the replaceable cartridge 404 that includes a cartridge housing 502, within which is positioned a first spring 504 biasing a first ball 506 against a precision seat 508 milled in housing 502. A second ball spring 520 biases a second ball 522 against a second precision seat 524 milled in housing 502. An O-ring 530 provides a seal between the replaceable check valve cartridge 404 and the valve body 402 (FIG. 4). A retaining screw 532 retains the first ball 506, first ball spring 504, second ball 522, and second ball spring 520 within cartridge housing 502 and compresses the second ball spring 520, biasing second ball 524 into second seat 524, which in turn compresses first spring 504 to bias first ball 506 into first seat 508. In operation, lubricant at pressure, typically from a divider valve (not shown), enters inlet 534 and forces first ball 506 and second ball 522 away from respective seats 508 and 524.

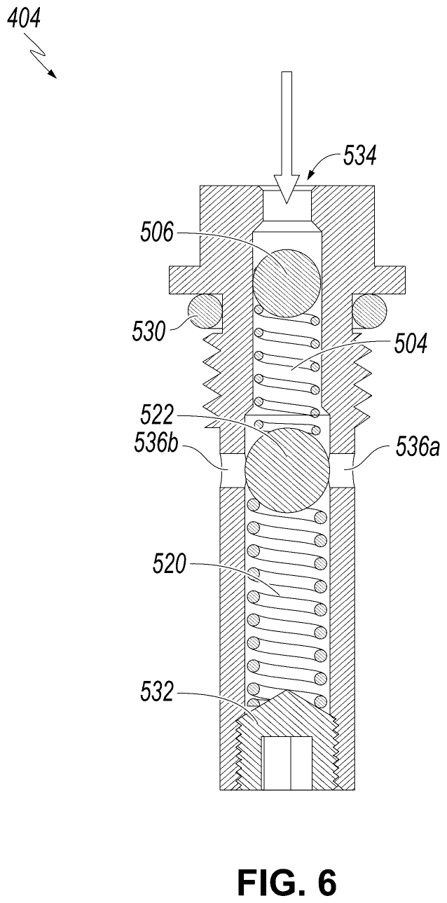

Once first ball 504 and second ball 522 are pushed away from their respective seats by the pressure of the incoming lubricant, the lubricant can flow through from inlet 534, around the first and second balls to outlets 536A and 536B, which are diametrically opposed openings in cartridge housing 502. FIG. 6 shows the valves with the balls displaced to allow lubricant to flow around the balls. Outlets 536A and 536B are not visible in FIG. 6.

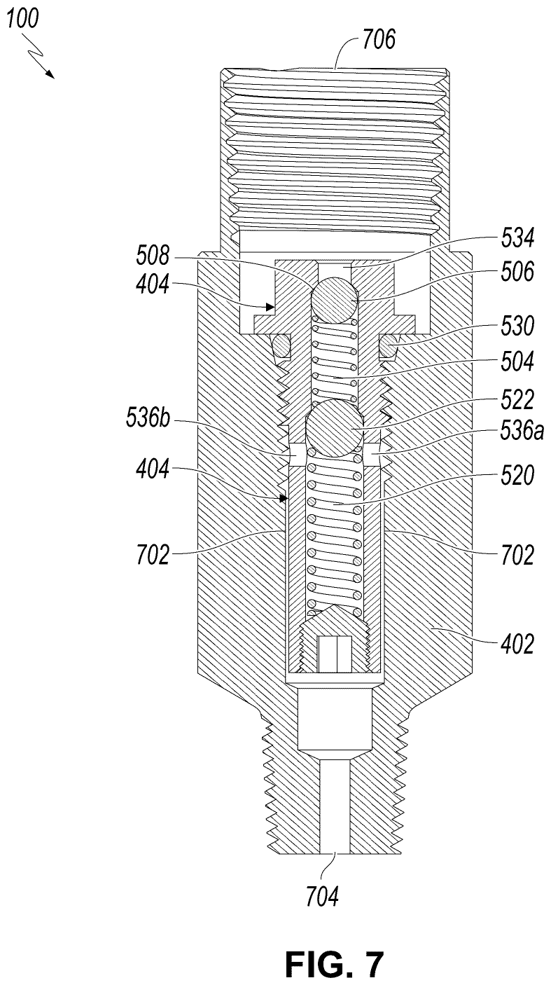

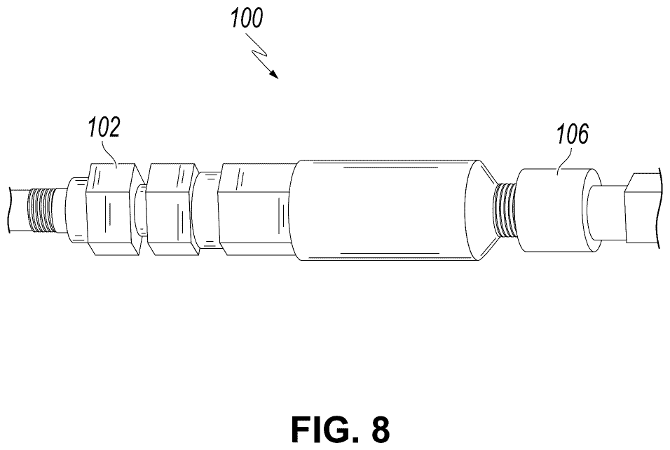

FIG. 7 shows a cross section of cartridge 404 inserted into body 402. Lubricant at high pressure, typically from a divider block (not shown) enters the cartridge check valve 100 at inlet 706. The lubricant passes into inlet 534 of replaceable cartridge 404 and displaces first ball 506 away from first ball seat 508 against the biasing force of first ball spring 504, allowing lubricant to pass and to displace second ball 522 against the bias of second ball spring 520. Lubricant then flows past second ball 522 and through outlets 536A and 536B into an annular gap 702 between the outer surface of cartridge 404 and the inner surface of body 402. The lubricant then leaves the check valve 100 through outlet 704. FIG. 8 shows a CCV 100 connected to a lube line through inlet fitting 102 and outlet fitting 106.

Annular gap 702 provides an oil barrier between the valve outlet and the check valve balls and seats because surface tension maintains lubricant within the annular gap 702 when lubrication is not flowing through the valve. The oil barrier prevents gas and debris flowing back from the lubricated system from reaching the check valve balls and seating surfaces, thereby preventing damage.

FIG. 8 shows a cartridge check valve connected on both ends to a lubrication line.

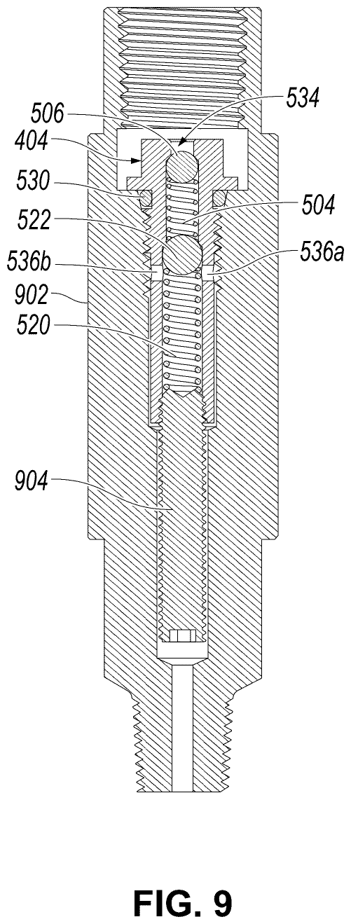

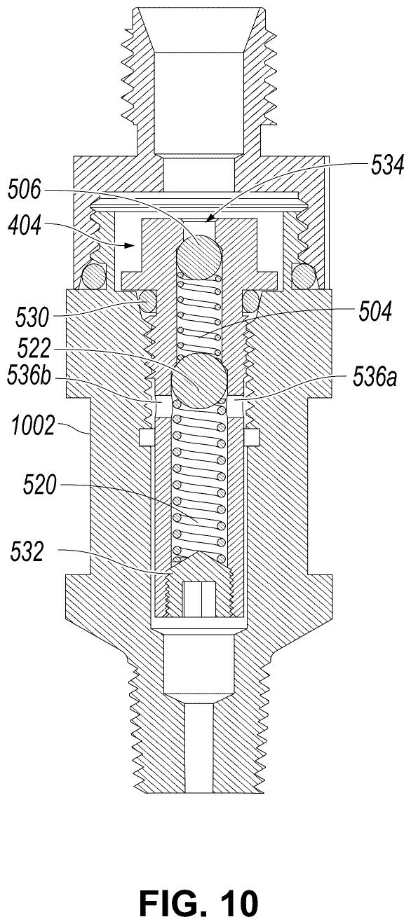

FIGS. 9 and 10 show alternative embodiments of the cartridge check valve. The cartridge check valve of FIGS. 9 and 10 uses the same cartridge 404 as shown the assembly shown in FIG. 7 but they use different check valve bodies, 902 and 1002, respectively. Plug 904 is longer than plug 532 used with housing 402 and housing 1002 in order to reach cartridge 404 in housing 902. Different check valve bodies and different cartridges can be used in different applications, and the invention is not limited to the particular configurations shown and described herein

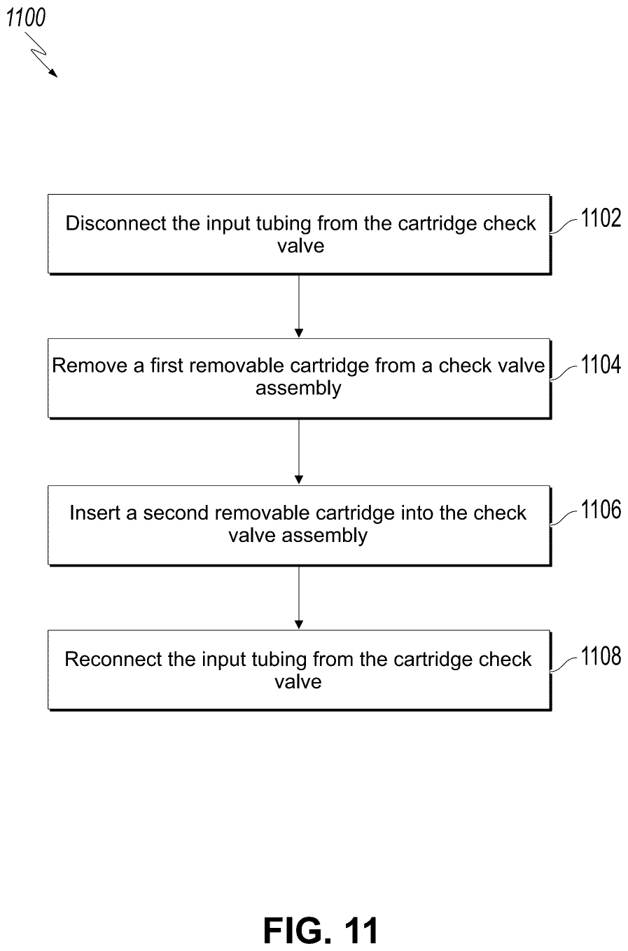

FIG. 11 is a flow chart showing a process of replacing a cartridge in a cartridge check valve. In step 1102, the input tubing from the cartridge check valve is disconnected. It may be necessary to remove the output tubing as well, and to take the cartridge check valve out of the lubrication system. In step 1104, a first removeable cartridge is removed from the check valve. In step 1106, a second removable cartridge is inserted into the check valve body. In step 1108, the input tubing is reconnected, and the check valve is put back into service.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A check valve for a high pressure, low volume lubrication system, comprising:
a body including:
a body inlet;
first threads;
a body outlet;
a replaceable cartridge comprising
a cartridge inlet communicating with the body inlet;
a first spring;
a first ball seat;
a first ball that can be biased by the first spring against the first ball seat;
a second spring;
a second ball seat;
a second ball that can be biased by the second spring against the second ball seat;
at least one cartridge outlet communicating with the body outlet;
second threads that mate with the first threads of the body to secure the replaceable cartridge in the body;
such that the cartridge includes the balls and seats and can be replaced in the body if the valve fails.

2. The check valve of claim 1 in which cartridge includes two cartridge outlets.

3. The check valve of claim 2 in which cartridge outlets open into a space between the cartridge and the body through which lubricant flows to an outlet of the body.

4. The check valve of claim 1 in which the first threads are female threads and the second threads are male threads.

5. A removable cartridge for a check valve, the removable cartridge configured to fit inside a check valve body, comprising:
a cartridge inlet;
a first spring;
a first ball seat;
a first ball that can be biased by the first spring against the first ball seat;
a second spring;
a second ball seat;
a second ball that can be biased by the second spring against the second ball seat;
at least one cartridge outlet communicating with the body outlet; and
threads that mate with threads of the body to secure the replaceable cartridge in the body.

6. A method of repairing a check valve composed of a body and a removable cartridge, comprising:
removing a first removable cartridge from a check valve body, the first removable cartridge including two balls, two springs, and two ball seats; and
inserting a second removable cartridge into the check valve body, the second removable cartridge including two balls, two springs, and two ball seats.

7. The method of claim 6 in which removing a first removable cartridge from a check valve comprises unscrewing the first removable cartridge from the check valve assembly.
